(19) United States
(12) Patent Application Publication
(10) Pub. No.: US 2026/0355820 A1
(43) Pub. Date: Nov. 12, 2026

(54) METHOD OF MAKING A CARBIDE POWDER

(71) Applicant: WOLFRAM BERGBAU UND HÜTTEN AG, St. Martin im Sulmtal (AT)

(72) Inventors: Thomas ZIMMERL, St. Martin im Sulmtal (AT); Raphael ROYER, Hanau (DE); Annegret BICHERL, St. Martin im Sulmtal (AT)

(21) Appl. No.: 19/140,103

(22) PCT Filed: Dec. 18, 2023
(86) PCT No.: PCT/EP2023/086265

§ 371 Date: Jun. 17, 2025

(30) Foreign Application Priority Data
Dec. 20, 2022 (EP) 22215111.0

(51) Int. Cl. B22F 9/04; B22F 8/00; C22B 1/24; C22B 3/22; C22B 7/00

(52) U.S. Cl. CPC B22F 9/04; B22F 8/00; C22B 1/24; C22B 3/22; C22B 7/007; B22F 2009/041; B22F 2302/10

(57) ABSTRACT

The present invention relates to a method of making a carbide powder from cemented carbide scrap, wherein the cemented carbide scrap is subjected to an acid treatment where the metal binder is dissolved, thus forming a carbide residue including carbide skeleton parts, which is then milled into a carbide powder. The invention also relates to a powder made according to the method as well as a cemented carbide made using the carbide powder.

This invention relates to a method of making a carbide powder from cemented carbide scrap. The invention also relates to a carbide powder made according to such process as well as a cemented carbide made from such carbide powder.

### BACKGROUND

Recycling of cemented carbides has been known for a long time and several processes for recycling are used in the art. One of the most common processes is the Zn-process, where the Co binder in the cemented carbide scrap is dissolved in molten Zn and where the Zn is then removed by distillation.

There is an increased demand for recycling of cemented carbide for both environmental and economic reasons. Availability of primary raw materials is limited and extraction of these requires a lot of resources.

Although, the Zn-process is considered efficient, it is not environmentally friendly, and has a high energy demand. The final carbide product obtained from the Zn-process contains a considerable amount of metal binder, usually Co, but also other metals such as grain growth inhibitors such as Cr, V etc. present in the scrap will to a large extent remain in the final carbide product.

In recent years, the fraction of recycled material in the production of cemented carbide has increased which leads to higher demands on the quality of the recycled carbide powder. Due to the increased fraction of recycled material, certain elements can be accumulated over time in the recycled material when recycling the cemented carbide repeatedly. If not removed during recycling, some of the elements originating from the coatings and/or residues like e.g. brazing residues can cause defects in the microstructure of the cemented carbide if the amounts are too high.

It is an object of the present invention to obtain an environmentally friendly and energy efficient recycling method for cemented carbide scrap where the carbide powder is of high quality.

It is another object of the present invention to obtain a recycling method for cemented carbide scrap that reduces the amount of grain growth inhibitors such as Cr, V etc.

It is an object of the present invention to obtain a method of removing residues and/or coatings from cemented carbide scrap where the remaining cemented carbide scrap is recycled.

### DETAILED DESCRIPTION OF THE INVENTION

The present invention relates to a method of making a carbide powder from cemented carbide scrap comprising tungsten carbide and metal binder. Said method comprising the steps:
a) subjecting the cemented carbide scrap to an acid treatment to dissolve metal binder in an acid solution, where the acid is H₂SO₄ with a concentration of between 0.4 and 10 N, for a time period of at least 24 h at a temperature of between 15 and 99 °C, at atmospheric pressure, where the cemented carbide scrap during the acid treatment is in a stationary state, and thereby forming an acid solution comprising the dissolved metal binder and a solid fraction comprising carbide skeleton parts, wherein the carbide skeleton parts are formed by dissolving the metal binder in at least the outer portion of the original cemented carbide scrap,
b) separating the acid solution from the solid fraction,
c) if the solid fraction comprises parts of the original cemented carbide scrap where metal binder is still present in the inner portion as a cemented carbide residue, the carbide skeleton parts are separated from the cemented carbide residue
d) crushing the carbide skeleton parts into a carbide residue and,
e) milling the carbide residue to form a carbide powder.

By cemented carbide scrap is herein meant solid cemented carbide pieces in the shape of cutting inserts, drills, end mills, mining buttons, rolls etc.

By cemented carbide is herein meant a sintered material comprising grains of a hard phase embedded in a metallic binder where the hard phase comprises at least 50 wt % WC. Other hard phase constituents that can be present is carbides, nitrides or carbonitrides of one or more of Nb, Ti, Ta, Cr, V etc.

The metallic binder can be any metallic binder used in the art of cemented carbides, e.g. one of Fe, Co and Ni, or alloys thereof. The most commonly used binder is Co.

If necessary, the cemented carbide scrap undergoes one or more sorting steps. The sorting step have several purposes, one is to eliminate scrap that is not cemented carbide, e.g. cermets (where the hard phase is mainly TiCN or TIC), steel, ceramics etc.

Once the scrap not being cemented carbide has been removed from the rest, also the cemented carbide pieces are sorted into different categorizations based on size, shape etc.

In one embodiment of the present invention the cemented carbide scrap is sorted by using a marking already present on the cutting tools/cemented carbide pieces. One examples of such marking is described in US2021/0229175. Such marking can give information on chemical composition, type of coating etc. and the scrap can thereby be handled in batches so that a more predictable composition of the final carbide powder can be produced.

In one embodiment of the present invention, the cemented carbide scrap is crushed into smaller pieces before the following process steps. The crushing can be done using any mechanical means suitable for the purpose, e.g. a crusher, shredder, hammer mill, (gravity) drop hammer etc. If the crushed cemented carbide scrap is crushed into small enough pieces prior to the acid treatment, the metal binder will be dissolved throughout the whole piece. How small the pieces should be after crushing for the metal binder to be dissolved throughout depends on the type of scrap.

In one embodiment of the present invention, when the cemented carbide scrap is crushed prior to being subjected to the acid treatment, no other process step/treatment is done to the crushed material prior to being subjected to the acid treatment, i.e. the acid treatment is applied directly after the crushing step.

If a cleaning and/or decoating step is required, the crushing can either be performed before or after the cleaning and/or decoating step.

In one embodiment of the present invention the cemented carbide scrap is less suitable for crushing, the scrap is subjected to the acid treatment directly.

Whether or not the cemented carbide scrap is suitable for crushing or not depends on the type of scrap, the size of the pieces and also the physical properties of the scrap (such as hardness and toughness). Also, if the pieces of cemented carbide is small enough for the metal binder to be dissolved throughout, no crushing step is required.

In order to dissolve the metal binder, the cemented carbide scrap is subjected to an acid treatment by placing the scrap in an acid solution comprising sulfuric acid (H₂SO₄) and water, with a concentration (normality) of between 0.2 and 10 N, preferably between 0.3 and 6 N to dissolve the binder.

The temperature of the acidic solution is between 15 and 99 °C, preferably between 50 and 90 °C.

During the acid treatment, the cemented carbide scrap is in a stationary state. By that is herein meant that the cemented carbide scrap pieces are still during leaching, i.e. no mechanical interference like e.g. continuous milling etc. on the cemented carbide scrap is applied. Since it is desired to maintain the grain size of the WC grains, mechanical interference during the leaching step will break some of the WC grains and the recycled carbide powder will have limited use.

The acid treatment is done at atmospheric pressure. By that is herein meant that no pressure is applied.

In one embodiment of the present invention, the acid treatment is performed without any applied electric current.

The cemented carbide pieces are remained in the acid solution for a time between 24 h and 100 days, preferably between 3 and 50 days.

After the acid treatment, the dissolved metal binder will be present in the acid solution and the rest of the cemented carbide scrap will form a solid fraction.

The solid fraction comprises the parts of the cemented carbide scrap from where the metal binder has been removed by the acid treatment which is herein called a carbide skeleton part. By that is herein meant that the part still has its original shape but that the absence of the metal binder causes the carbide particles to be held together loose enough to facilitate breaking it up using mechanical means, like e.g. crushing. The solid fraction can also comprise a powder fraction of carbides originated of carbide skeletons that has spontaneously disintegrated.

If the cemented carbide scrap has been subjected to a crushing step prior to the acid treatment, the acid will dissolve the metal binder throughout the whole piece and the whole piece will form a carbide skeleton.

In the event that the cemented carbide scrap is subjected to the acid treatment without being subjected to a crushing step, the binder might not be dissolved throughout the whole piece in one acid treatment step.

When no crushing step has been performed prior to the acid treatment, the solid fraction after the acid treatment will also contain parts where the metal binder still remains, a so-called cemented carbide residue. Usually, the metal binder still remains in the inner portion of the original cemented carbide scrap, whereas the outer portion is a carbide skeleton part from which the metal binder has been removed during the acid treatment.

The carbide skeleton part can, if necessary, be further released from the cemented carbide residue, i.e. the inner portion, by mechanical means, i.e. vibrations, sieving etc. The cemented carbide residue parts are then removed from the carbide skeleton parts and the acid solution preferably by sieving and/or magnetic separation. The cemented carbide residue parts that still contains metal binder will still be magnetic due to the presence of the metal binder whereas the skeleton part is not magnetic since the metal binder has been removed.

The cemented carbide residue parts will then be treated as cemented carbide scrap and will be subjected to one or more additional acid treatments until all metal binder is dissolved.

After the acid treatment, the metal binder is present in the acidic solution as ions.

The acid solution is removed, and the carbide skeleton parts are washed to remove any remaining acid. Water is usually used for washing.

Preferably the metal binder dissolved in the acid solution is recovered by precipitation after the carbide residue has been separated from the acid solution.

The washed carbide skeleton parts are then preferably dried.

In order for the carbide skeleton parts to be suitable for milling, the carbide skeleton usually needs to be broken up using mechanical means into smaller pieces for it to be suitable for the milling step. This is preferably done by crushing to form a carbide residue.

The milling can be done by any milling technique common in the art of carbides, such as ball mill, attritor mill, bead mill, jet mill etc.

In one embodiment of the present invention, the cemented carbide scrap is subjected to a cleaning and/or decoating step to remove residues and/or coating from the cemented carbide scrap prior to recycling. The method comprises the steps of:
subjecting the cemented carbide scrap to a pre-acid treatment in an acid solution having a concentration of between 0.2 and 10 N, for a time period of between 30 minutes and 72 hours, at a temperature of between 15 and 99 °C,
removing the residues and/or coating by mechanical means.

The most common type of cemented carbide scrap having a coating is cutting tools such as inserts, drills, end mills etc. Typical coatings are those deposited using conventional PVD (physical vapor deposition) and CVD (chemical vapor deposition). Recently, also more advanced deposition techniques have become more common like e.g. HIPIMS (high power impulse magnetron sputtering) which is a PVD technique.

Cutting tools such as inserts are commonly deposited with either PVD or CVD technique, whereas cutting tools such as drills or endmills are usually coated using PVD technique.

By residues are herein meant any unwanted particles or elements that are beneficial to be removed from the cemented carbide scrap prior to recycling the cemented carbide.

Examples of residues are brazing residues, rock residues, residues of work piece material welded to a cutting tool during machining operations etc.

Mining tools and wear parts of cemented carbide are usually brazed to a holder, drill head etc. Before being recycled, the cemented carbide part is separated from the holder and some of the solder can still remain on the cemented carbide part. Mining tools can also contain parts of rock that are wedged into the mining tool during operation. Cutting tools can also contain brazed parts which can leave braze residues.

The acid used in the acid solution in the pre-acid treatment for removing residues and/or coatings, can be any acid that is able to dissolve the metal binder under the residues and/or coating, preferably the acid is one or more of sulfuric acid (H₂SO₄), chloric acid (HCl), acetic acid (CH₃COOH) or phosphorus acid (H₃PO₃), more preferably one or more of sulfuric acid (H₂SO₄) and hydrochloric acid (HCl), most preferably sulfuric acid (H₂SO₄). When the cemented carbide scrap contains brazing residues like e.g. solder, the solder can also, at least partly, be dissolved in the acid. The concentration of the acid solution is between 0.2 and 10 N, preferably between 0.3 and 6 N, more preferably between 0.5 and 5 N. The temperature of the acid solution can be between 15 and 99 °C, preferably between 50 and 90 °C. The time that the cemented carbide is subjected to the pre-acid treatment is between 30 minutes and 72 hours, preferably between 10 and 48 hours. The time is dependent on the concentration of the acid solution and the temperature.

In one embodiment of the present invention, the pre-acid treatment is performed without any applied pressure or electric current.

The cemented carbide pieces are preferably washed after the pre-acid treatment to remove any remaining acid. This is mainly done to avoid corrosion of the equipment.

The acid used in the pre-acid treatment can be re-used, for example it can be used when making a carbide powder according to the present invention.

After the pre-acid treatment, any residue and/or coating will still be present but with poor adhesion since the acid treatment has dissolved the metal binder in the outermost part of the cemented carbide and the residue and/or coating can thus be removed.

After the pre-acid treatment, the residues and/or coatings are removed from the cemented carbide scrap by mechanical means. By mechanical means is herein meant any type of mechanical treatment that can remove the residues and/or coating. Preferably the residues and/or coating is removed by blasting or tumbling. Following the mechanical treatment, the removed residues and/or coating residues are separated from the cemented carbide scrap by any suitable means like e.g. sieving, magnetic means etc.

In one embodiment of the present invention, after the pre-acid treatment, the residues and/or coating is removed from the cemented carbide scrap by blasting. Blasting can be used on all types of cemented carbide scrap but is especially useful for drills and end mills that are provided with flutes. If a coating is present in the flutes can be difficult to reach with other types of mechanical removal methods. The exact parameters of the blasting step, i.e. type of blasting media, blasting pressure, wet or dry blasting, nozzle size etc. can depend on several things for example the type of blasting equipment used and it is up the person skilled in the art to adjust the parameters so that the desired result is achieved.

In one embodiment of the present invention, after the pre-acid treatment, the residues and/or coating is removed from the cemented carbide scrap by tumbling. The most common type of tumbling is where pieces are placed in a rotating drum and where the pieces are allowed to collide against each other and against the walls of the drum.

Tumbling is specifically suitable when larger volumes of cemented carbide scrap is to be treated. The parameters for the tumbling process such as load of the drum, rotational speed etc. is set by a person skilled in the art depending on type and size of drum, size of the cemented carbide scrap etc.

In one embodiment of the present invention, the cemented carbide scrap is subjected to a mechanical treatment prior to the pre-acid step. The mechanical treatment can be any technique that can cause defects like e.g. cracks in a coating or even crush the cemented carbide scrap into smaller pieces. Examples of such techniques are tumbling, blasting and crushing. Causing defects or crushing the scrap can make it easier for the acid in the acid treatment to penetrate the coating in order to dissolve the metal binder. This step can be beneficial if the coating thickness is too large and/or if the coating is of a type that is very dense like e.g. HIPIMS coatings etc.

In one embodiment of the present invention, the method relates to a method of making a carbide powder from coated cemented carbide scrap where the method comprises the following steps:
a) subjecting the cemented carbide scrap to a cleaning and/or decoating step and a crushing step,
b) subjecting the crushed cemented carbide scrap to an acid treatment to dissolve metal binder in an acid solution, where the acid is H₂SO₄ with a concentration of between 0.2 and 10 N, for a time period of at least 24 h at a temperature of between 15 and 99 °C, at atmospheric pressure, where the cemented carbide scrap during the acid treatment is in a stationary state, and thereby forming an acid solution comprising the dissolved metal binder and a solid fraction comprising carbide skeleton parts, wherein the carbide skeleton parts are formed by dissolving the metal binder;
c) separating the acid solution from the solid fraction comprising carbide skeleton parts,
d) crushing the carbide skeleton parts into a carbide residue and,
e) milling the carbide residue to form a carbide powder.

In one embodiment of the present invention, the method relates to a method of making a carbide powder from uncoated cemented carbide scrap where the method comprises the following steps:
a) subjecting the cemented carbide scrap to a cleaning process and to a crushing step
b) subjecting the crushed cemented carbide scrap to an acid treatment to dissolve metal binder in an acid solution, where the acid is H₂SO₄ with a concentration of between 0.2 and 10 N, for a time period of at least 24 h at a temperature of between 15 and 99 °C, at atmospheric pressure, where the cemented carbide scrap during the acid treatment is in a stationary state, and thereby forming an acid solution comprising the dissolved metal binder and a solid fraction comprising carbide skeleton parts, wherein the carbide skeleton parts are formed by dissolving the metal binder;
c) separating the acid solution from the solid fraction comprising carbide skeleton parts,
d) crushing the carbide skeleton parts into a carbide residue and,
e) milling the carbide residue to form a carbide powder.

In one embodiment of the present invention, the method relates to a method of making a carbide powder from uncoated cemented carbide scrap where the method comprises the following steps:
a) subjecting the cemented carbide scrap to an acid treatment to dissolve metal binder in an acid solution where the acid is H₂SO₄ with a concentration of between 0.2 and 10 N, for a time period of at least 24 h at a temperature of between 15 and 99 °C, at atmospheric pressure, where the cemented carbide scrap during the acid treatment is in a stationary state, and thereby forming an acid solution comprising the dissolved metal binder and a solid fraction comprising carbide skeleton parts, wherein the carbide skeleton parts are formed by dissolving the metal binder in at least the outer portion of the original cemented carbide scrap;
b) separate the cemented carbide fraction where the metal binder still remains from the cemented carbide fraction from which the binder has been dissolved;
c) the cemented carbide fraction from which the binder has been dissolved will form a carbide residue;
d) separating the carbide residue from the acid solution and the metal binder;
e) subjecting the carbide residue to a milling step to form a carbide powder.

The present invention also relates to a carbide powder made according to the method described above.

The final carbide powder contains less than 1 wt % metal binder, preferably less than 0.5 wt % metal binder and more preferably less than 0.2 wt %.

In one embodiment of the present invention, the final carbide powder will contain at least 40%, preferably 50% less of Cr that what was present in the cemented carbide scrap from the beginning.

In one embodiment of the present invention, the final carbide powder will contain at least 20%, preferably 30% less of V that what was present in the cemented carbide scrap from the beginning.

The WC grain size in the final carbide powder will be aligned with the WC grain size in the cemented carbide scrap since the WC grains will go through the process almost completely unchanged.

The present invention also relates to the use of the recycled carbide powder to make a sintered cemented carbide where the hard phase in the cemented carbide consists of at least 50 wt % of the recycled carbide powder as described above, preferably at least 70 wt %, more preferably at least 90 wt % of the recycled carbide powder most preferably 100% of the recycled carbide powder. The recycled carbide powder is used in the same way as the conventional WC raw material and the cemented carbide is manufactured according to standard practice in the art, i.e. mixing the ingoing raw materials e.g. by wet milling, forming a slurry, spray drying, pressing and sintering.

### DRAWINGS

FIG. 1 shows a flowsheet of one of the embodiments of the present invention where A is the cleaning and/or decoating step, B the crushing step, C the acid treatment, D the step where the acid solution is separated from the solid fraction, E is the step where, if not all metal binder has been dissolved in the acid treatment, the cemented carbide scrap still containing metal binder is separated to be recycled for additional acid treatment, F the step where the carbide skeleton parts are crushed and G is the milling step.

FIG. 2 shows a Light Optic Microscope image of the sintered cemented carbide from Example 7.

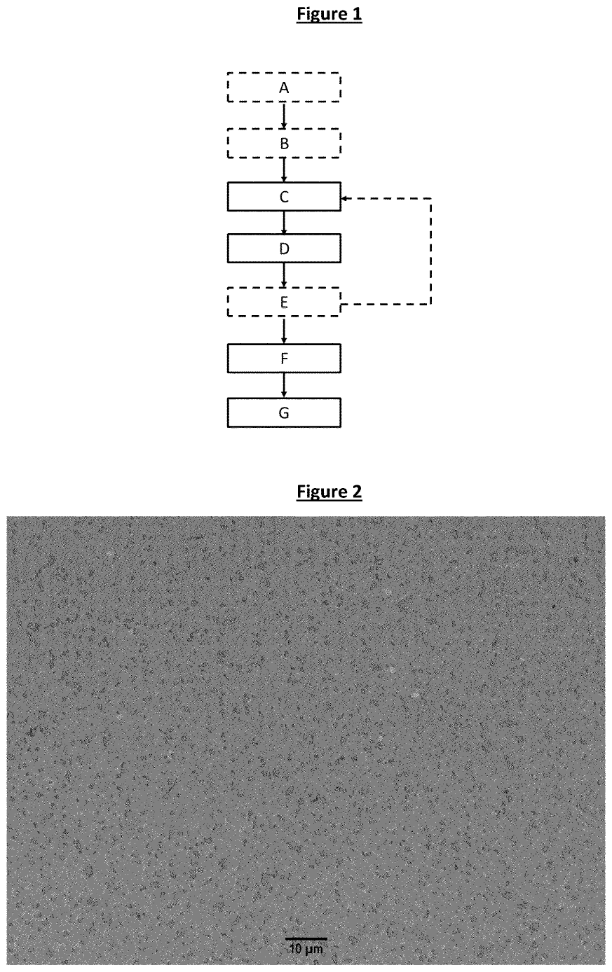

### EXAMPLE 1 (INVENTION)

Uncoated cemented carbide scrap in the shape of indexable inserts were crushed into smaller pieces and screened to below 8 mm in size. The scrap pieces were then placed in a vessel. Acid treatment was done in 12 wt % H₂SO₄ (2.6N) at 80 °C. In order to maintain the acid concentration in the vessel. In order to maintain the acid concentration in the vessel the acid concentration is continuously adjusted during the acid treatment. The total time for the acid treatment was 17 days.

At the end of the acid treatment process, the acid was removed, and the remaining carbide skeleton parts were washed in 4 washing cycles to remove any remaining acid residue.

The remaining carbide skeleton parts were broken to a size of less than 1 mm and then milled in a ball mill to form a carbide powder.

The final carbide powder was analyzed, and the element analysis and grain size are listed in Table 1. The remaining elements are W and impurities, all values are in wt %. The oxygen and carbon content were analyzed using a LECO instrument (WC-600) and the other elements were analyzed using XRF (X-ray fluorescence) using a Panalytical Axios Max Advanced instrument.

TABLE 1

| | | | | | | | | FSSS |
|---|---|---|---|---|---|---|---|---|
| Co | C | Cr | Ta | Ti | Nb | Fe | O | (μm) |
| <0.10 | 6.18 | 0.07 | 0.96 | 0.95 | 0.52 | 0.13 | 0.57 | 1.25 |

### EXAMPLE 2 (INVENTION)

Pre-broken rods of cemented carbide were used as cemented carbide scrap starting material.

The scrap pieces were then placed in a vessel. Leaching was done with 12 wt % H2SO4 (2.6N) and at 60 °C. The acid concentration was kept as stable as possible. In order to maintain the acid concentration in the vessel the acid concentration is continuously adjusted during the acid treatment. The total time for the acid treatment was 20 days.

At the end of the leaching process, the acid was removed and the remaining carbide skeleton parts were washed in 3 washing cycles to remove any remaining acid residue.

After leaching, the carbide skeleton parts had a Co content of 0.1%.

The remaining carbide skeleton parts were deagglomerated (<1 mm) and then milled in a ball mill to form a carbide powder.

The final carbide powder was analyzed and the properties are listed in Table 2.

TABLE 2

| | | |
|---|---|---|
| FSSS a.s. | 1.34 | μm |
| Co (ICP-OES) | 1200 | ppm |

¹FSSS a.s. Fisher subsieve sizer - as supplied

### EXAMPLE 3 (INVENTION)

A batch of coated inserts were subjected to an acid treatment in 12 wt. % H2SO4 (2.6N) at 70 °C for 24 h. After the acid treatment the inserts were washed with water and 1500 g of inserts were then subjected to a tumbling process by placing the inserts in an 800 ml mill and the mill was filled up to ⅔ with water. The mill was then run for 36 h.

After the tumbling, the cemented carbide scrap and the fine coating residue was separated through a sieve (1 mm).

When comparing the cemented carbide scrap before and after the decoating process, a removal of more than 70% of the coating could be concluded by visual inspection.

### EXAMPLE 4 (INVENTION)

13.75 tons of coated inserts were treated for 24 h in 12 wt. % H2SO4 (2.6N) at 80 °C. After the acid treatment the inserts were washed the inserts were subjected to a tumbling process using a large mill (1 ton). The mill was then run for 36 h.

After the tumbling, the cemented carbide scrap and the fine coating residue was separated through a sieve (3 mm).

When comparing the cemented carbide scrap before and after the decoating process, a removal of more than 70% of the coating could be concluded by visual inspection.

### EXAMPLE 5

For comparison, a batch of coated inserts were subjected to a tumbling process in water for 36 hours. The inserts were washed and when investigated, more than 60% of the coating still remaining after visual inspection.

The inserts were then subjected to a recycling process (Zn process) in order to form a recycled cemented carbide powder. When analyzing the recycled cemented carbide powder, coating flakes and coating residues could be detected.

### EXAMPLE 6

Drills and endmills coated with a PVD coating were prepared.

One batch was subjected to an acid treatment in 12 wt. % H2SO4 (2.6N) at 60 °C for 24 h. This batch will herein after being called Invention 1.

For comparison, the fraction of the coated cutting tools not subjected to the acid treatment was divided into 3 batches, Comparative 1-3.

Invention 1 and Comparative 1-3 were subjected to a dry blasting treatment using an injection blasting system with manual movement of the blasting gun performed in a suction blasting cabinet “Boy 100” equipped with a filtration unit. The blasting media was with Al₂O₃ (mesh 120). The pressure was 5 Bar and the nozzle diameter was 8 mm and the nozzle distance was 70 mm. The blasting time was varied and can be seen in Table 1. The cutting tools were inspected visually, and the result is given in Table 3.

TABLE 3

| | Acid | Blasting time | Coating status after |
|---|---|---|---|
| | treatment | (sec) | blasting |
| Invention 1 | Yes | 60 | No coating |
| Comparative 1 | No | 25 | Coating still present |
| Comparative 2 | No | 70 | Coating still present |
| Comparative 3 | No | 120 | Coating still present |

As can be seen in the example is that the removal rate of the coating is not sufficient with only blasting, even if the blasting time longer, whereas the process according to the invention shows a high removal rate.

### EXAMPLE 7

A recycled carbide powder made according to Example 1, was used to make a sintered cemented carbide. The carbide powder was mixed with 6.5 wt % Co and 2 wt % PEG (amounts based on the total powder weight) to form a powder blend. The powder blend was mixed with a milling liquid (ethanol/water) to form a slurry which was subsequently pan dried and then pressed into a green body.

The green body was, after debinding at 310 °C for 120 minutes, sintered in vacuum at 1450 °C for 60 minutes.

The microstructure of the sintered cemented carbide was investigated using a Light Optical Microscope (LOM). A LOM image is shown in FIG. 2, where it can be seen that the microstructure is fully dense.

1. A method of making a carbide powder from cemented carbide scrap comprising tungsten carbide and metal binder, said method comprising the steps:
subjecting original cemented carbide scrap to an acid treatment to dissolve the metal binder in an acid solution, wherein the acid is H₂SO₄ with a concentration of between 0.4 and 10 N, for a time period of at least 24 h at a temperature of between 15 and 99 °C, at atmospheric pressure, wherein the cemented carbide scrap during the acid treatment is in a stationary state, and thereby forming an acid solution including the dissolved metal binder and a solid fraction including carbide skeleton parts, wherein the carbide skeleton parts are formed by dissolving the metal binder in at least an outer portion of the original cemented carbide scrap;
separating the acid solution from the solid fraction;
if the solid fraction includes parts of the original cemented carbide scrap where metal binder is still present in an inner portion as a cemented carbide residue, the carbide skeleton parts are separated from the cemented carbide residue;
crushing the carbide skeleton parts into a carbide residue; and
milling the carbide residue to form a carbide powder.

2. The method according to claim 1, wherein the cemented carbide residue is separated from the carbide skeleton parts using magnetic means.

3. The method according to claim 2, wherein the cemented carbide residue where the metal binder still remains will be treated as cemented carbide scrap and will be subjected to the method steps repeatedly until all metal binder is dissolved.

4. The method according to claim 1, wherein the acid solution has a concentration of between 1 and 6 N.

5. The method according to claim 1, wherein the cemented carbide scrap is subjected to the acid treatment for a time period of between 1 and 100 days at a temperature of between 50 and 90 °C.

6. The method according to claim 1, wherein the cemented carbide scrap is subjected to a crushing step prior to the acid treatment and the acid treatment is applied directly after the crushing step.

7. The method according to claim 1, wherein the cemented carbide scrap is sorted by using information in an already existing marking on the cemented carbide scrap pieces.

8. The method according to claim 1, wherein the cemented carbide scrap is subjected to a cleaning and/or decoating step prior to the acid treatment.

9. The method according to claim 8, wherein the cleaning and/or decoating step comprises subjecting the coated cemented carbide scrap to a pre-acid treatment in an acid solution having a concentration of between 0.2 and 10 N, for a time period of between 30 minutes and 72 hours, at a temperature of between 15 and 99 °C after which the coating is removed using mechanical means.

10. The method according to claim 9, wherein the mechanical means are selected from tumbling or blasting.

11. The method according to claim 8, wherein a mechanical pre-treatment prior to the pre-acid treatment is performed, wherein the mechanical pre-treatment is selected from tumbling, blasting and crushing.

12. A carbide powder made from recycled cemented carbide scrap made according to the method of claim 1, wherein the powder has a metal binder content of less than 1 wt %.

13. The carbide powder according to claim 12U, wherein the metal binder content is less than 0.5 wt %.

14. A use of the carbide powder according to claim 12, for making a sintered cemented carbide body, wherein at least 50 wt % of a hard phase consists of the carbide powder.
